(19) United States
(12) Patent Application Publication
(10) Pub. No.: US 2003/0205340 A1
(43) Pub. Date: Nov. 6, 2003

(54) Modular garage door

(75) Inventor: Paul Nadar, Woodbridge (CA)

Correspondence Address: Dennison Associates, Suite 301, 133 Richmond Street West, Toronto, ON, M5H 2L7, CA

(73) Assignee: Royal Group Technologies Limited

(21) Appl. No.: 10/418,069

(22) Filed: Apr. 18, 2003

(30) Foreign Application Priority Data
Apr. 25, 2002 (CA) 2,383,457

(51) Int. Cl. E06B 3/06

(52) U.S. Cl. 160/236

(57) ABSTRACT

Door sections for an overhead folding garage door formed by assemblying rows of panels with transverse styles with elongated top and bottom rails cut or selected to the length of the door opening, the panels and the styles and the rails having interengaging means whereby the panels and styles are connected to the rails.

### FIELD OF THE INVENTION

This invention relates to overhead folding doors such as overhead folding garage doors in which a plurality of door sections are hinged together and, more particularly, to the provision of modular door sections for such doors to accommodate different sizes of door openings.

### BACKGROUND OF THE INVENTION

The housing and building industry has become such that there is a proliferation of different sizes of garage doors required to meet the industry's need.

Widely used convention overhead folding garage doors comprise a plurality of hinged door sections each section being in the form of a horizontal row of raised or decorative panels generally having rectangular borders formed by horizontal rails connected at spaced intervals by vertical styles.

These sections are hinged together to provide the folding action as the door is raised or lowered with rollers carried by the door running in trackways extending vertically up the sides of the door opening and extending generally horizontally into the interior of the garage.

Because of the large variations in the size of the garage door now demanded by the building industry, manufacturers can no longer rely on making a standard sized door or door section to meet the requirements of potential customers, but must provide doors having a wide variation in door width and to a lesser extent in door heights.

The cost of tooling to be able to provide an adequate number of different garage door sizes in an attempt to fully serve the garage door market is very onerous making it difficult to compete economically with individual manufacturers making only one or a limited number of garage door sizes.

It is the object of this invention to provide modular door sections for overhead folding garage doors which will enable the production of a wide range of garage door sizes utilizing such door sections. It is also an object to enable such modular door sections to be produced through the assembly of a minimum number of components thereby greatly reducing the tooling and other manufacturing costs involved in providing such doors whereby such doors can be efficiently produced at relatively low cost.

### SUMMARY OF THE INVENTION

According to the invention, the hinged sections of the overhead folding garage doors are formed as rows of panels by assembling preformed panel and style members with top and bottom rails whose lengths are selected to span the opening to be closed by the door.

For assembly with the rails, the upper and lower edges of the panel and style members and the juxtapositioned edges of the top and bottom rails are provided with interengaging means whereby the required panel and style members required to make up the required row of panels extending the length of the rails can be attached to the rails.

The rails need only be cut to the desired length while the panel and style members, where necessary, are provided with interengaging or locking means so that they can be connected together along the length of the rails to change the width of the door section.

It will be understood that the door sections made up of the rows of panels will be hinged together and in this connection the invention provides that the upper edges of the upper rails and the lower edges of the lower rails are configured to interfit to provide a close finger pinch free sliding fit.

According to a preferred form of the invention, the top and bottom rails are formed as extruded members which can be cut to the desired length. Such extruded rails may be metal, i.e. aluminum or more preferably plastic. Again, while the panel and style members may be made of different materials, according to the most preferred form of the invention, they are formed as molded plastic members preferably molded from low cost composite plastic materials.

### BRIEF DESCRIPTION OF THE DRAWINGS

FIG. 1 is a perspective view of an 8 foot garage door employing four sections of rows of panel formations employing the invention. Such sections are hinged together as will be understood to enable the door to fold as it is moved upwardly or downwardly by virtue of the usual rollers running in trackways extending up the sides of the door opening and turning to extend generally horizontally into the interior of the garage;

FIG. 2 is a front elevational view of the component parts ready to be assembled to form a door section comprising top and bottom rails, a row of panel formations separated by styles extending transversely of the row and end styles for attachment to the row of panel formations.

FIG. 3 is a front elevational view of the components of FIG. 2 in assembled form;

FIG. 4 is a view similar to FIG. 3 but illustrating that the end styles can be cut for fine adjustment of the transverse length of the row of panel formations;

FIG. 5 is a view of the row of panel formations illustrated in FIG. 2 with the end styles connected ready to be assembled with the top and bottom rails;

FIG. 6 is an end view of the assembled row of panels and top and bottom rails showing the connections therebetween;

FIG. 7 is a view similar to FIG. 6 but showing somewhat narrower top and bottom rails;

FIG. 8 is a diagramatic elevational view illustrating how the panel formation and end styles are utilized as modular elements with extended lengths of rails to provide a door section twice the length of the door section of FIG. 3;

FIG. 9 is a broken away exploded perspective view illustrating how the adjoining rows of panel formations are connected together by a central style provided with a series of spaced keeper loops on each side thereof (only one side being shown) to receive and engage depending tongues provided on the ends of the panel sections;

FIG. 10 is a front elevational view of a one piece integral row of panel formations separated by transverse styles and terminated by end styles for forming door sections for a 9 foot garage door;

FIG. 11 is a front elevational view of an elongated row of panel formations and transverse styles for a 10 foot garage door centered between a single panel with end style at each end thereof for forming door sections of 14 feet or 15 feet depending on the size of the single panel formations at the ends of the 10 foot panel formation;

### DETAILED DESCRIPTION ACCORDING TO THE PREFERRED EMBODIMENTS OF THE PRESENT INVENTION

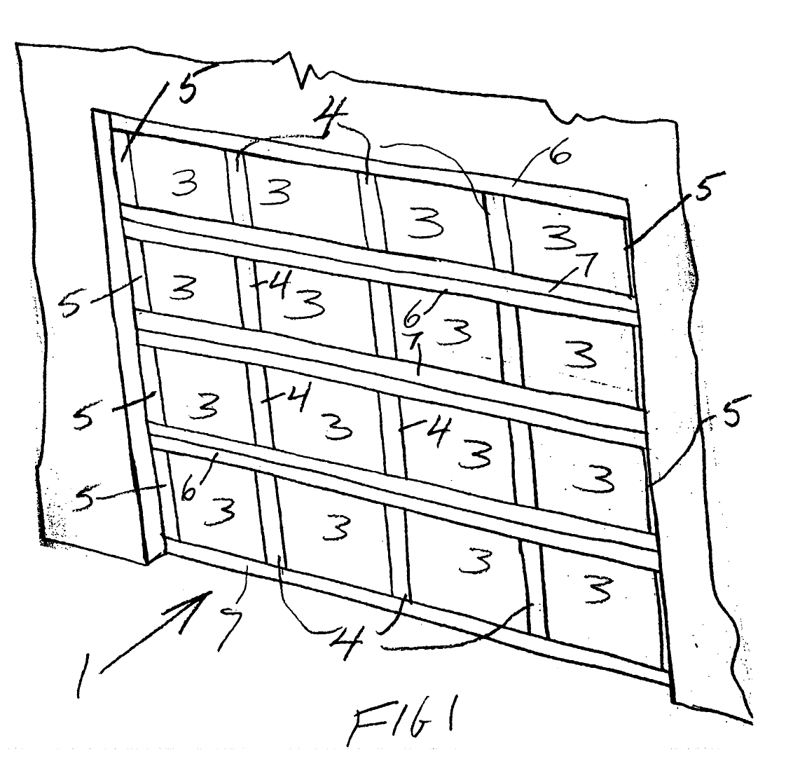

FIG. 1 illustrates an 8 foot garage door 1 having door sections to which the invention has been applied and is shown as having four sections 2 each comprising a row of panel formations 3 separated by transverse styles 4 and terminating in end styles 5.

It will be understood that the sections 2 are hinged together so that they fold in the usual overhead garage door opening and closing movement controlled by rollers moving in the appropriate tracks, features not deemed necessary to illustrate here as the present invention is directed to the changing of the length of the rows of panel formations to fit different widths of garage door openings and as well different door opening heights.

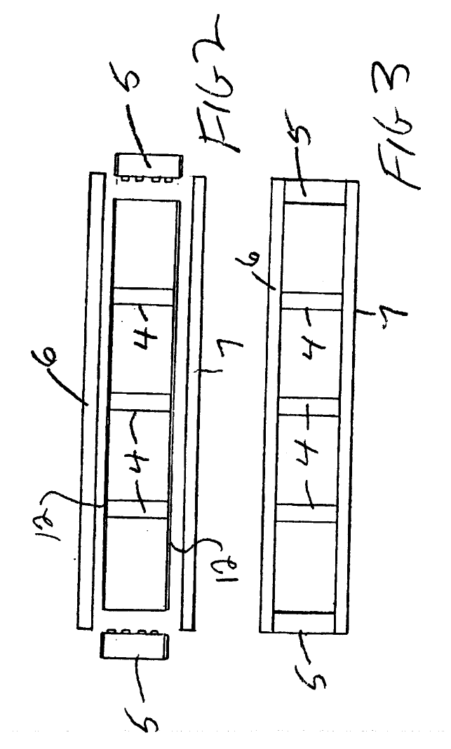

Each of the transverse sections 2 of the garage door 1 comprises an assembly of separate top and bottom rails 6 and 7, end styles 5 and an integral row of panel formations and transverse styles 3 and 4 respectively as illustrated in FIG. 2.

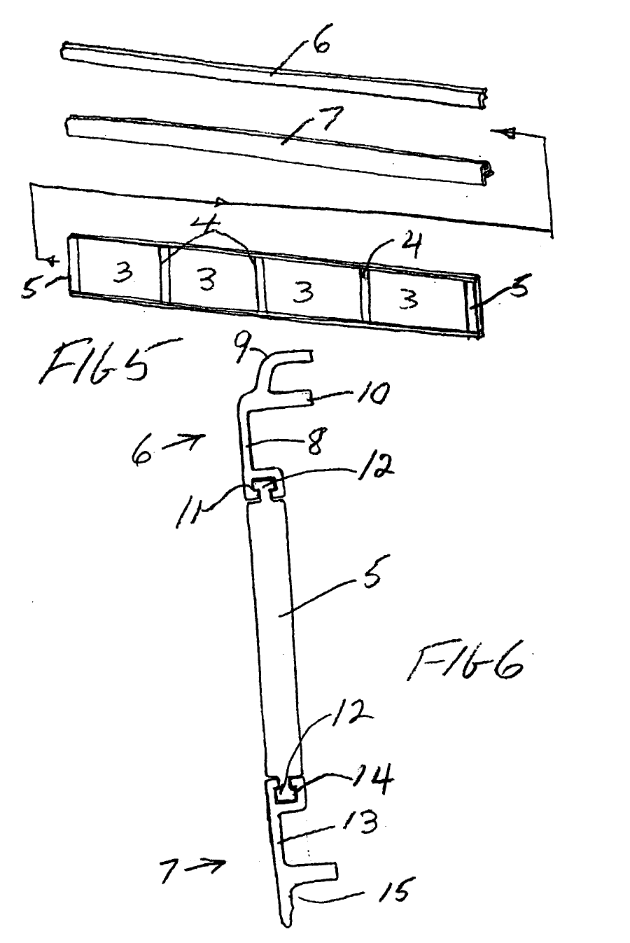

FIG. 3 shows these components assembled while FIG. 5 shows the manner of assembly of the row of panel formations 3 to which the end styles 5 have been attached to the top and bottom rails 6 and 7 respectively. In this connection, it will be seen from FIG. 6 that the top rail 6 comprises a vertical leg 8 having an offset knee portion 9 below which is a short reinforcing flange 10.

The lower end of the leg 8 is formed to provide an undercut groove 11 extending along its length to slidably receive and interlock with a necked tongue 12 extending along the length of the panel row 3 and also provided on the upper ends of the end styles 5.

The bottom rail 7 has a vertical leg 13 provided at its upper end with an undercut groove 14 to slidably receive and interlock with a necked tongue identical to the necked tongue 12 and similarly designated at 12.

The lower end of the vertical leg 13 of the lower rail is configures to provide a receiving area 15 to receive and conform with the knee portion 9 of a juxtaposed lower transverse section 2 to provide a close following movement of the leg 13 with the knee portion of the justaposed lower section during hinging of the sections to prevent pinching of the fingers.

By having separate rails 6 and 7, these rails simply can be cut to their requisite length to span the door opening, i.e. the 8 foot opening of the door of FIG. 1 and the panel formations connected to the rails by virtue of the interconnecting means which, as illustrated in FIG. 6, comprise the undercut rail grooves 11 and 14 and the necked tongues 12. In its broadest aspect, the invention envisages rails made of any suitable material such as wood, metal or plastic and having any suitable means for interengaging with the row of panels and styles. Again, each panel formation and each style could be made of any suitable material with any suitable interengaging means to effect the desired connection to the rails whereby the door sections can be built up as modular units with the length of the door section being changed by increasing the length of the rails to fit the garage door opening and the number of panel formations or the lengths of the panel formations which are interconnected with the rails to provide the row of panel formations spanning the length of the rails or door opening.

According to the preferred form of the invention, the rails 6 and 7 comprise longitudinal extrusions of plastic material preferably composite plastic material and the row of panel formations 3 with their transverse styles 4 are preferrably formed of injection molded plastic, preferably a composite plastic as a one piece member.

Similarly, the end styles 5 comprise injection molded composite plastic members.

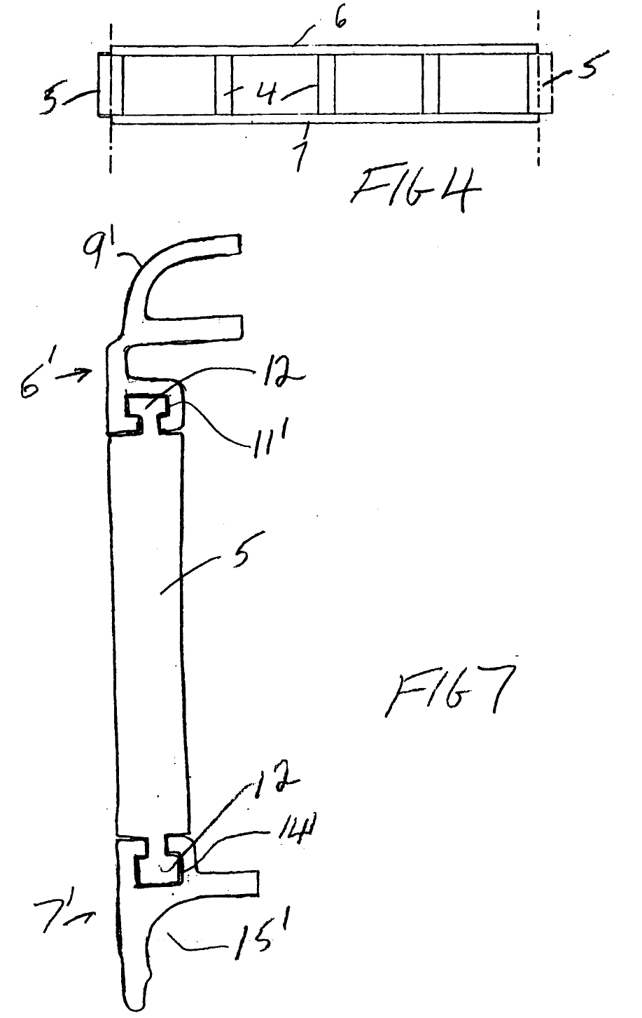

As the door section illustrated in FIGS. 1, 2, 3, 5 and 6 is for an 8 foot door width, the top and bottom rails 6 and 7 are, of course, 8 feet in length while the row of panel formations 3 has a length of 89 inches. The end styles each have a width of 3.5 inches so that when these end styles are assembled with the panel row 3 the total length of these components will be 96 inches, i.e. 8 feet. If there is any error in these end styles 5, they can be cut as illustrated in FIG. 4.

The depth of the combined row of panels and rails, i.e. the dimension from the top of the top rail 6 to the bottom of the bottom rail 7 in FIG. 6 is some 24 inches or 2 feet.

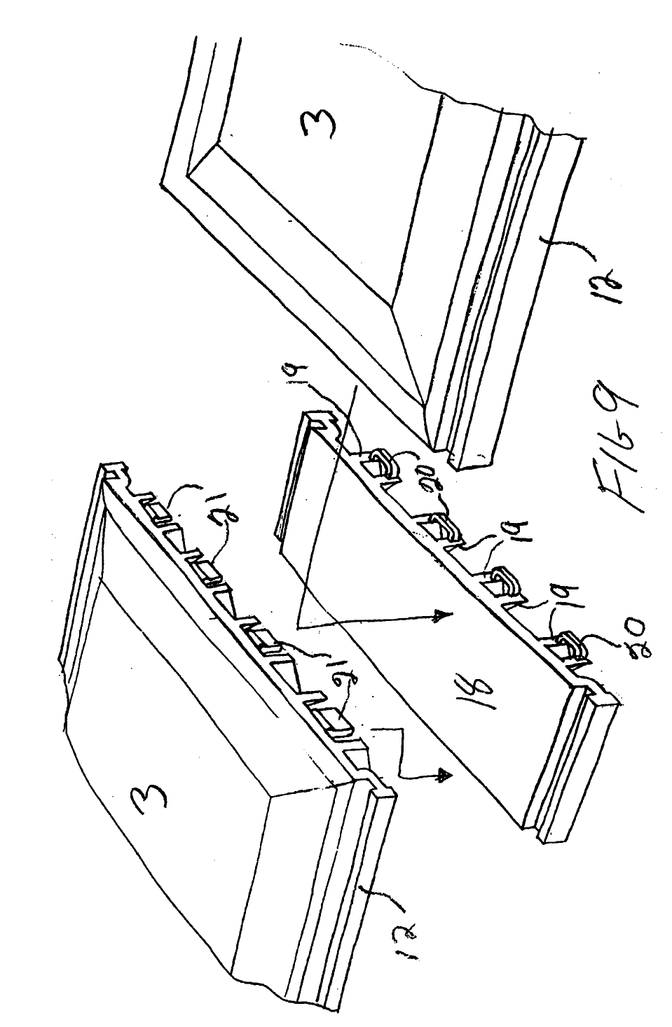

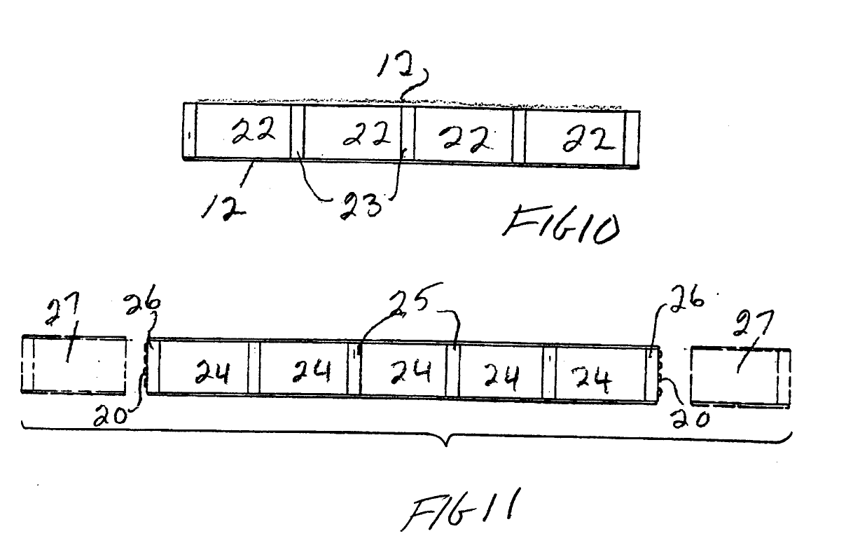

While the door sections described to date are for the 8 foot wide garage door opening, FIG. 8 illustrates the formation of a door section for a 16 foot wide door opening. In this case, top and bottom rails 16 and 17 respectively have the same cross section configuration as rails 6 and 7. They are now 16 feet long. Assembled with these rails are two rows of panel formations 3 with their end styles 5 at the outer ends of the sections with the inner ends being joined by an intermediate style 18 connected to both of the panel formations 3.

FIG. 9 is an enlarged exploded view showing how the intermediate style 18 connects to the row of panel formations 3 (shown about to be assembled in FIG. 8). As illustrated in FIG. 9, the style 18 has at each side thereof (only the right side being shown in FIG. 9) depending legs 19 carrying outwardly projecting loops 20 whose planes are at right angles to the depending legs. These loops are adapted to receive spaced tongues 21 projecting downwardly from the end edges of the panel formations 3.

For a 9 foot door width, rails 6 and 7 will be cut to a 9 foot length to span across the door opening. In this case, the row of panels 22 with the transverse styles 23 throughout are formed as one dedicated injection molded panel formation formed to slidably interlock with the top and bottom rails as discussed above.

For a 10 foot wide door opening, the rails 5 and 6 of course will be cut to the 10 foot length and, in this case, an injection molded row of panel formations 24 includes a row of 5 panel formations separated by intermediate but integral styles 25 and end styles 26 which are also integral but are provided with projecting loops 20 for attachment with other individual panels 27 all as shown in FIG. 11.

The panels 27, for example, may comprise 2 foot panels so that the addition of these panels to the row of panel formations 24 will produce a 14 foot door section when mated with 14 foot top and bottom rails.

It will be understood that the panel formations 24 and 27 will carry the necked tongues 12 along their top and bottom edges for slidably interlocking with the rails.

For a 15 foot door section, the panels 27 can be replaced by panels having an increased length of 6 inches.

FIG. 9 illustrates the panel formations 3 as generally rectangular raised formations but it will be understood that other formations may be employed.

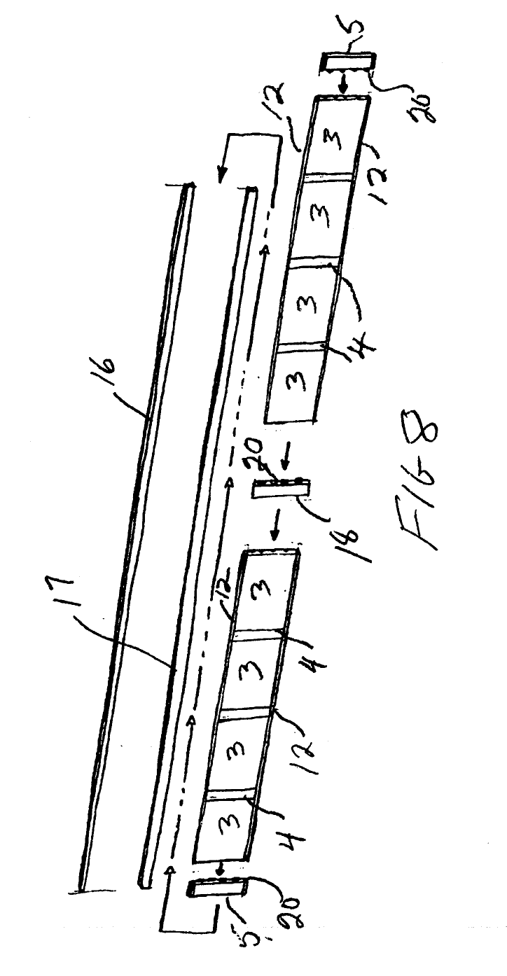

While the depth of the panel formations, that is, the dimension between the top and bottom of the top and bottom rails in FIG. 6 is selected to be 24 inches, this dimension can be changed by changing the depth of the top and bottom rails. Thus, in FIG. 7, the top and bottom rails 6′ and 7′ are shallower than the respective rails 6 and 7 but have the basic configurations thereof. That is, the top rail 6′ has a knee portion 9′ and an undercut groove 11′ and the bottom rail 7′ has an undercut groove 14′ and a receiving area 15′.

In the case of FIG. 7, the span between the upper end of top rail 6′ and the lower end of bottom rail 7′ is some 21 inches so that the height of a garage door employing four of such sections would be some foot less than the height of a door employing the rails of FIG. 6. This selection of the depth of the sections plus, of course, the number of sections employed in the door enables the height of the door to be varied as required.

It will be understood that various modifications in the various components and their materials may be made without department from the scope of the appended claims.

The embodiments of the invention in which an exclusive property or privilege is claimed are defined as follows:

1. An overhead folding door section for transversely spanning between the sides of a door opening, said section comprising elongated top and bottom rails having a length to span said door opening, a row of panel formations mounted between and extending the length of said top and bottom rails, the bottom edge of said top rail and the top edge of said panel formations having interengaging means connecting said panel formations to said top rail, and the bottom edge of said panel formations and the top edge of said bottom rail having interengaging means connecting said panel formations to said bottom rail.

2. An overhead door section as claimed in claim 1 in which said panel formation comprises a series of individual panels.

3. An overhead door section as claimed in claim 1 in which said panel formations comprise raised panels separated by styles extending transversely of said row.

4. An overhead door section as claimed in claim 3 in which the panels at the outer end of said row of panels are terminated by end styles extending transversely of said row.

5. An overhead door section as claimed in claims 3 or 4 in which said top and bottom rails are plastic extrusions.

6. An overhead door section as claimed in claims 3 or 4 in which said top and bottom rails are plastic extrusions and said panels and styles are of molded plastic.

7. A folding door section as claimed in claim 5 in which the plastic of said extrusions and panels and styles comprises a composite plastic material.

8. An overhead folding door section as claimed in claim 1 in which panel formations comprises an integrally molded row of panels with adjoining panels separated by styles extending transversely of said row, the outer edges of the panels at the ends of said row being terminated by end styles extending transversely of said row.

9. A folding door section as claimed in claim 8 in which at least one of said end styles is molded integrally with said row of panels.

10. A folding door section as claimed in claim 8 in which at least one of said ends styles is detachably connected to the outer edge of one of said end panels.

11. A folding door section as claimed in claims 1 or 8 in which the interconnection between said panel formations and said rails comprise slideable interlocking formations.

12. An overhead folding door section for transversely spanning between the sides of a door opening, said section comprising elongated top and bottom rails having a length to span said door opening, a row of panel formations separated by styles extending transversely of said row and with the ends of said row of panel formations terminating in styles extending transversely of said row, said panel formations and styles being secured between and extending the length of said rails with the bottom edge of said top rail and the top edges of said panel formations and styles having interengaging means to connect said panel formations and styles to said top rail and the bottom edge of said panel formations and styles and the top edge of said bottom rail having interengaging means to connect said panel formations and styles to said bottom rail.

13. An overhead door section as claimed in claim 12 in which said rails are extruded plastic members and said panel formations and styles are molded plastic members.

14. An overhead door section as claimed in claims 12 or 13 in which at least one of said panel formations and styles are separate members and have interengaging means connecting same together.

15. An overhead door section as claimed in claims 12 or 13 in which at least some of said panel formations are separate members and have interengaging means connecting same together.

16. An overhead door section as claimed in claim 13 in which said row of panel formations and styles comprise a one piece molded member presenting four panel formations separated by styles and two separate end styles, said member having fastening means at its ends and said end styles have fastening means engaging said member fastening means to secure said end styles to the ends of said member.

17. An overhead door section as claimed in claim 13 in which said row of panel formations and styles comprise a one piece molded member.

18. An overhead door section as claimed in claims 12, 13, 14, 15, 16 or 17 in which said top rail has a convex knee shaped upper edge and said bottom rail has a concave recessed lower edge to snuggly and rotatably receive the convex upper edge of the top rail or a juxtaposed lower door section.

19. An overhead door section as claimed in claim 17 in which said rails have selected depths to control the transverse width of said door section.
